(19) United States
(12) Patent Application Publication
(10) Pub. No.: US 2026/0024143 A1
(43) Pub. Date: Jan. 22, 2026

(54) FINANCIAL MANAGEMENT SYSTEM AND METHODS

(71) Applicant: David Macchia, Boston, MA (US)

(72) Inventor: David Macchia, Boston, MA (US)

(21) Appl. No.: 18/785,653

(22) Filed: Jul. 26, 2024

Related U.S. Application Data
(60) Provisional application No. 63/673,296, filed on Jul. 19, 2024.

(51) Int. Cl. G06Q 40/06

(52) U.S. Cl. CPC G06Q 40/066; G06Q 40/063; G06Q 40/06

(57) ABSTRACT

A method includes processing circuitry obtaining user inputs associated with an investment. The user inputs may indicate an investment period after which distribution of a realized return of the investment will begin, and a desired realized return for the investment at an end of the investment period. The method also includes obtaining one or more additional factors that affect the realized return of the investment from another system, and estimating a funding amount that the user must fund the investment with, before or during the investment period, to realize the desired realized return after the investment period based on the user inputs and the one or more additional factors.

### RELATED APPLICATIONS

This Application claims priority (under 35 USC 119 (e)) to U.S. Provisional Application No. 63/673,296, filed Jul. 19, 2024, the entire contents of which are incorporated herein by reference.

### BACKGROUND

This invention relates to financial management and, more particularly, to a system and methods in support of financial management.

Investment strategies generally target a value of an investment at a future time. Typically, several assumptions are needed to generate the strategy to account for unknowable variables, like future rates of return, that are used in prospective computations. If these assumptions fail to come to fruition, the strategy will fail to achieve the desired target value.

### SUMMARY

According to one or more embodiments, a method includes processing circuitry obtaining user inputs associated with an investment. The user inputs may indicate an investment period after which distribution of a realized return of the investment will begin, and a desired realized return for the investment at an end of the period. The method also includes obtaining one or more additional factors that affect the realized return of the investment from another system, and estimating a funding amount that the user must fund the investment with, before or during the investment period, to realize the desired realized return after the investment period based on the user inputs and the one or more additional factors.

According to another embodiment, a non-transitory computer-readable medium stores instructions which, when processed by one or more processors, result in implementation of a method. The method includes processing circuitry obtaining user inputs associated with an investment. The user inputs may indicate an investment period after which distribution of a realized return of the investment will begin, and a desired realized return for the investment at an end of the period. The method also includes obtaining one or more additional factors that affect the realized return of the investment from another system, and estimating a funding amount that the user must fund the investment with, before or during the investment period, to realize the desired realized return after the investment period based on the user inputs and the one or more additional factors.

The foregoing has outlined some of the pertinent features of the disclosed subject matter. These features are merely illustrative.

### BRIEF DESCRIPTION OF THE DRAWINGS

The examples described throughout the present document will be better understood with reference to the following drawings and descriptions. In the figures, like-referenced numerals designate corresponding parts throughout the different views.

FIG. 1 is a process flow of a financial management method according to some embodiments;

FIG. 2 is a process flow of the financial management method with additional aspects according to some embodiments;

FIG. 3 is a process flow of the financial management method with further aspects according to some embodiments;

FIG. 4 is a block diagram of a financial management system according to some embodiments;

FIG. 5A is an exemplary view of a user interface for a financial management system according to some embodiments;

FIG. 5B is an exemplary view of the user interface of FIG. 5A indicating an adjusted funding amount; and

FIG. 5C is an exemplary view of the user interface of FIG. 5A indicating an adjustment to the funding amount shown in FIG. 5B.

### DETAILED DESCRIPTION

Reference will now be made to the drawings to describe the present disclosure in detail. It will be understood that the drawings and exemplified embodiments are not limited to the details thereof. Modifications may be made without departing from the spirit and scope of the disclosed subject matter.

In some investments, income generated by the investment may be of greater interest than the value of the investment. In retirement planning, for example, an investor may be interested in generating a particular income for some duration (e.g., 20 years following retirement, for the investor's indeterminate lifetime). In this regard, factors like interest rate can have a significant effect. For example, for an investment value of $1,000,000, the income generated by a 6-month CD paying an interest rate of 7 percent would be nearly $6000 per month, while the income generated by a savings account paying 0.09 percent interest would be closer to $80 per month. Thus, the process of planning to realize a particular future income is not straightforward, because assumptions must be made (e.g., about investment earnings during the investment period, about earnings on realized return after the investment period, about the real income generated by the realized return), and some or all of those assumptions may be wrong. Incorrect assumptions may result in an investor failing to achieve their desired retirement income. Thus, managing investments to achieve a specific future income goal presents a challenge for retail investors and participants in 401(k) and other defined contribution plans.

Current retirement planning tools, like the many retirement calculators available through websites, generally use inputs regarding years until retirement and periodic (e.g., monthly) savings amount along with assumed rates of return for the investment period (e.g., years until to retirement) and for the retirement period (e.g., based on user input or an assumed life expectancy) to estimate a realized return on investment that will be available at the start of retirement and the income that value is estimated to generate. Such tools are not tied to any particular investment and do not guarantee the realized return, and their usefulness even as estimations are limited by the assumptions.

Different types of investments may be used for retirement or other income planning. Some examples include an annuity, mutual fund, life insurance policy, bonds, exchange traded funds, or a portfolio of different investments, for example as part of a 401(k) plan. As noted, a particular retirement income is often targeted by investors. In this case, assumptions about duration of the investment period (i.e., a period after which distribution of a realized return will begin), rate of return of the investment over the investment period, and other parameters may be used to estimate a funding amount that the investor must put into the investment, as a lumpsum or periodic payment, to attain the targeted retirement income. However, some of the assumptions used to estimate the funding amount may prove to be wrong. For example, the prospective rate of return assumption may not, and likely will not, match the actual rate of return over the investment period.

The inventor has recognized that planning for future income would benefit from managing a particular investment or investment portfolio with adjustments to account for differences between assumed and actual variable values. Such management may create a personal defined benefit pension for individual investors, such as those participating in 401(k) or 403(b) plans. For example, a defined benefit life insurance policy, defined benefit annuity, defined benefit retirement plan, or the like may be created by using the financial management system and methods according to some embodiments described herein. Guaranteeing a desired income based on the particular investment or investment portfolio may require adjusting the investment funding throughout the investment period to account for changes in what the invested funds are earning, as well as factors that may affect the real income generated from the realized return of the investment. The inventor has recognized that facilitating adjustments to the funding amount of an investment over the investment period can allow an investor to achieve their desired outcome (e.g., targeted retirement income, value of investment at the end of the investment period), referred to as the realized return on the investment.

According to some embodiments, a financial management system is provided that gives an investor a periodic (e.g., yearly) update to reassess the funding amount. For example, an adjustment to the funding amount may be suggested at the time of the update based on actual rate of return over the previous period, obtained through communication with an external system, and resulting updated assumptions about rate of return moving forward. The financial management system may additionally allow the investor to change other parameters (e.g., expected age of retirement, duration of income) to assess whether an additional lumpsum payment or increased periodic payments are needed to achieve the desired realized return, which in turn generates the desired income.

The inventor has also recognized that some investors may want to consider financial factors (e.g., inflation rate, currency exchange rate, inflation rate in a country other than the United States (US)) additional to rate of return and user and investment-specific parameters when determining the funding amount needed for a desired realized return. For example, an investor who expects to retire and live in France may want to adjust their retirement funding during the investment period to account for both the inflation rate in France and the exchange rate from US dollars to euros to ensure that their realized return matches their initial expectations for the income from their investment.

According to some embodiments, the financial management system provides a user increased capability to manage complex investments whose value is affected by a variety of factors. In some embodiments, the management system permits an investor to select one or more additional factors to be considered in the estimate of funding amount needed to attain a desired realized return. The management system may communicate with one or more external systems to obtain the selected additional factors to be used in the estimate to provide a customized display according to the user selections. Some factors may affect the target realized return and, thus, the funding needed to reach the updated realized return while other factors may only affect the funding needed to reach a previously determined realized return on the investment. Based on the various features, the management system may provide increased, customized functionality to a user to more accurately track and predict an account value and facilitate payment adjustments that depend on a variety of factors (e.g., interest rate or other rate of return, inflation rate, currency exchange rate, etc.) to ultimately achieve the desired realized return and income.

The inventor has further recognized that monitoring investments and/or other financial factors to provide information to an investor within the typical period for an update (e.g., within a year) may better-prepare the investor to understand and address changes that may otherwise only be reported at the pre-defined periods. According to some embodiments, the financial management system monitors interest rate or other rate of return, inflation rate, currency exchange rate, and/or other factors, which may be user-selected factors, and alerts the investor if a change that exceeds a threshold change is observed before the pre-defined reporting period. The monitoring may include monitoring external systems for updates. Based on the monitoring, a customized display may be provided any time according to customized conditions.

The financial management system, according to the various embodiments described, represents a significant technical improvement over current internet-based estimation systems that only rely on assumptions and cannot guarantee a preselected future income.

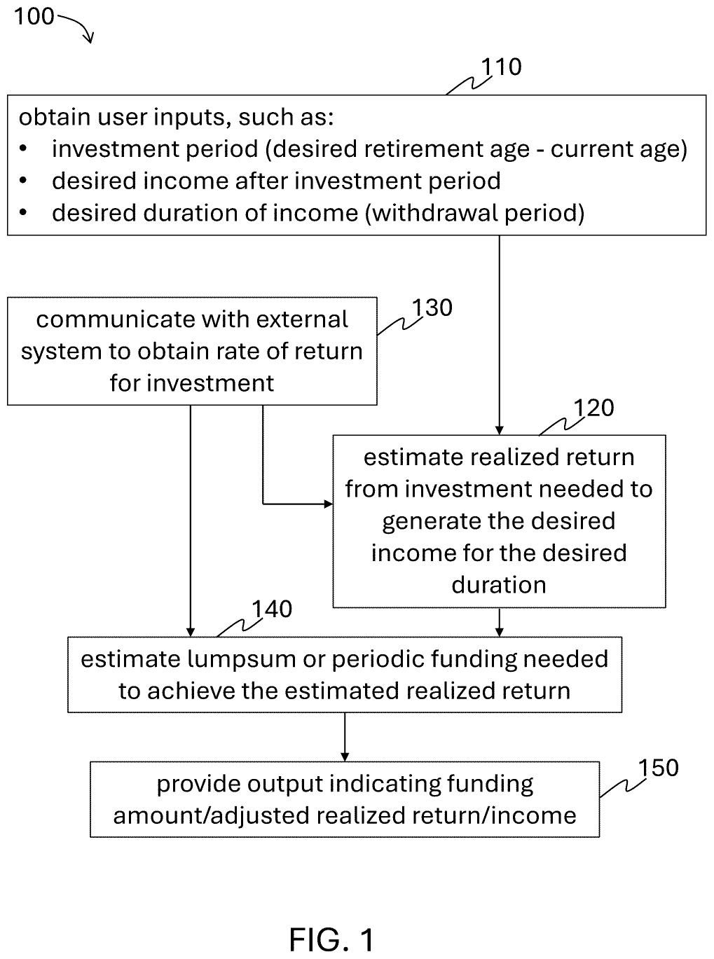

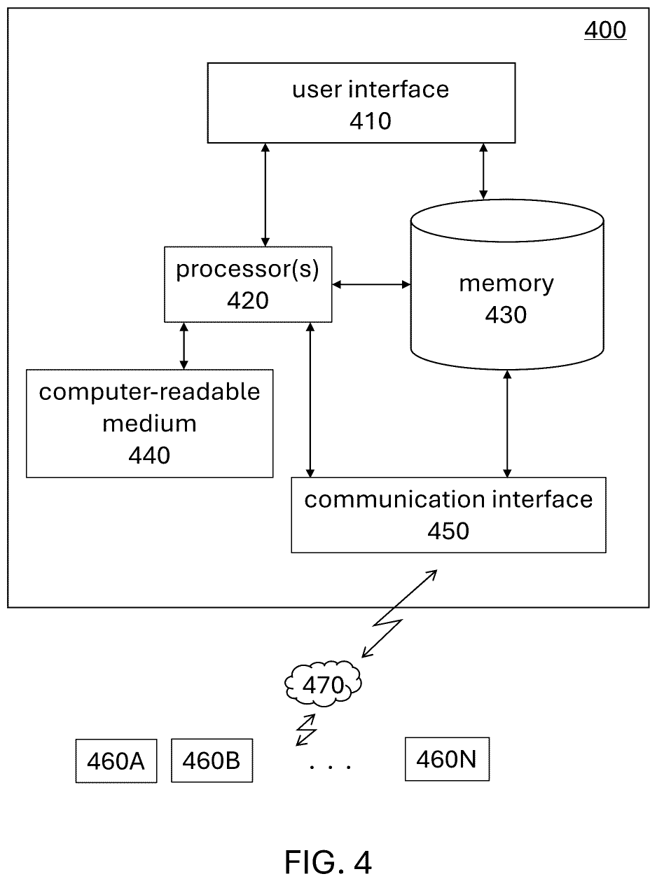

FIG. 1 is a process flow of a financial management method 100 according to some embodiments. The processes shown in FIG. 1 may be implemented by a financial management system 400, which is discussed with reference to FIG. 4. The processes may be implemented when the investment is initially established by the investor, at periodic intervals (e.g., yearly anniversary), and whenever an investor chooses to initiate the processes.

At 110, obtaining user inputs may include obtaining an investment period, which is a duration for which the investment is intended to grow without any withdrawal of income or the value. The investor may provide current age and a desired age of retirement, for example, such that the investment period is computed as a difference between the two. Obtaining user inputs may also include obtaining desired income after the investment period and desired duration of that income. That is, once the investment period ends, it marks the beginning of a withdrawal period, which is a duration for which income is withdrawn from the investment. Rather than a particular duration, the investor may indicate a desire to receive the income for the rest of their life, for example. In this case, profile information provided by the investor may be used to estimate life expectancy and determine the duration in conjunction with an indicated retirement age or age at which the investment period is to end. In some cases, an investment may allow income for the lifetime of two people (e.g., investor and spouse). Thus, both life expectancies may be considered in estimating the duration (i.e., withdrawal period).

The user inputs obtained at 110 may be obtained via a user interface 410 of the financial management system 400, as discussed with reference to FIG. 4. The user inputs may be stored (e.g., in memory 430 (FIG. 4)). In subsequent implementations of the method 100, the stored values may be used for variables that are not modified or re-entered by an investor.

At 120, estimating a realized return from the investment that is needed to generate the desired income for the desired duration (i.e., withdrawal period) uses the inputs obtained at 110. In a simplified approach by which earnings are not considered, the estimate of realized return needed could be set to the total desired income indicated by the user inputs. The total desired income is the desired income per interval of the withdrawal period (e.g., desired income per month) * number of intervals in the withdrawal period (e.g., number of months during the desired duration of income). More realistically, a rate of return may be used for the withdrawal period while accounting for the reduction in value of the investment based on the withdrawals of income. A rate of return may be estimated based on the communication at 130.

At 130, the financial management system 400 may communicate with one or more external systems 460 to obtain rate of return information for the investment. The particular external system 460 from which rate of return information is obtained is selected according to the investment. For example, an interest rate may be obtained from a bank or a rate of return may be obtained from an insurance company, a mutual fund provider, an exchange traded fund sponsor, 401(k) recordkeeper, or turnkey asset manager. The rate of return used at 120 (i.e., expected rate of return during the withdrawal period) may be estimated as the current rate of return obtained at 130 unless a different rate of return during the withdrawal period is already associated with the investment. For an investment with a guaranteed rate of return (i.e., guaranteed income) during the withdrawal period, for example, the realized return obtained at 120 is not an estimate.

At 140, estimating lumpsum or periodic funding needed to achieve the estimated realized return, estimated at 120, uses current rate of return information obtained, at 130, from an external system 460 associated with the investment. If periodic funding is planned rather than only a lumpsum, the rate of return is used along with the increase in value associated with the periodic funding payments to estimate the amount of the period funding payments needed to achieve the realized return. When the method 100 is implemented at any time after the investment has already been established and funded (e.g., with an initial funding amount or with periodic payments over some number of intervals), the rate of return information obtained at 130 may differ from a prior estimate of rate of return used at 140 and may result in a different lumpsum or periodic funding amount being estimated at 140 than before.

That is, for example, when the investment was established, rate of return at the time of establishment may have been used to determine the lumpsum or periodic payment amount at 140. A year later, the actual rate of return from the time of establishment to the one-year anniversary may have been different than the rate of return at the time of establishment (unless the investment is associated with a guaranteed rate). In that case, the processes at 140 may indicate that a lumpsum or periodic funding amount adjustment is needed to achieve the realized return from 120.

At 150, providing output may refer to providing textual and/or graphic output to the investor. The output may include a lumpsum funding amount and/or a periodic funding amount (e.g., monthly payment) from 140 to achieve the realized return associated with the desired income from 120. When the method 100 is not implemented during initiation of the investment but, instead, after the investment has been established (e.g., one year after establishment of the investment), the output may represent an adjustment in the lumpsum or periodic funding amount from a previous output based on a change in rate of return obtained at 130. In addition, when the method 100 is implemented after establishment of the investment, providing output at 150 may include indicating, to the investor, an adjusted realized return and/or income during the withdrawal period that may result from failing to modify the lumpsum or periodic funding amount as indicated.

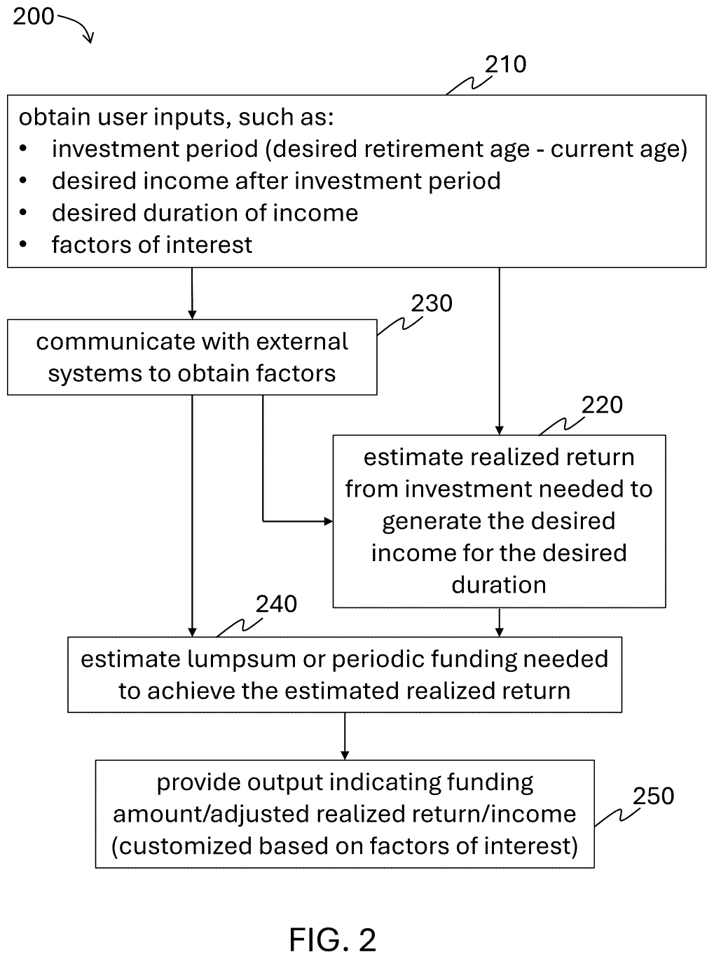

FIG. 2 is process flow of a financial management method 200 according to some embodiments. The method 200 includes additional aspects to those discussed with reference to FIG. 1. The additional aspects are discussed but details of similarities with the method 100 are omitted. At 210, obtaining user inputs may additionally include obtaining factors of interest to the investor. Factors of interest may be factors that affect the realized return estimated at 220 (e.g., projected inflation, which may affect real income during the withdrawal period) or factors that affect the payment estimated at 240. The factors indicated as part of the user inputs may be additional to the rate of return of the investment. Exemplary factors of interest include inflation (current and/or projected for the withdrawal period), currency other than US dollars to indicate a particular currency exchange rate as a factor, and projected inflation associated with the currency.

At 230, rate of return and additional factors indicated in the user inputs may be obtained from external systems 460 (FIG. 4). The financial management system 400 may determine which external system 460 (e.g., third party server, website) to communicate with based on the factors to be obtained. The additional factors provided as user inputs at 210 may be selected (e.g., from a pull-down menu). In that case, an external system 460 may be mapped to each selectable factor and the external systems 460 mapped to the selected factors may be contacted. In some embodiments, artificial intelligence may be employed to identify external systems 460 and obtain factors at 230 that are selected or otherwise input as user inputs at 210.

The processes at 220 and 240, while similar to those at 120 and 140, respectively, may be affected by one or more factors in addition to the rate of return information obtained at 230. At 250, providing output may be adjusted to indicate the selected or otherwise input factors at 210. Thus, the output provided according to processes at 250 may be customized according to the user input at 210. For example, if current inflation rate were the only additional factor indicated as a user input at 210, a standard output at 250 may be modified to include a display of the current inflation rate. In addition, the effect of inflation rate on the estimated lumpsum or periodic funding amount at 240 may be indicated.

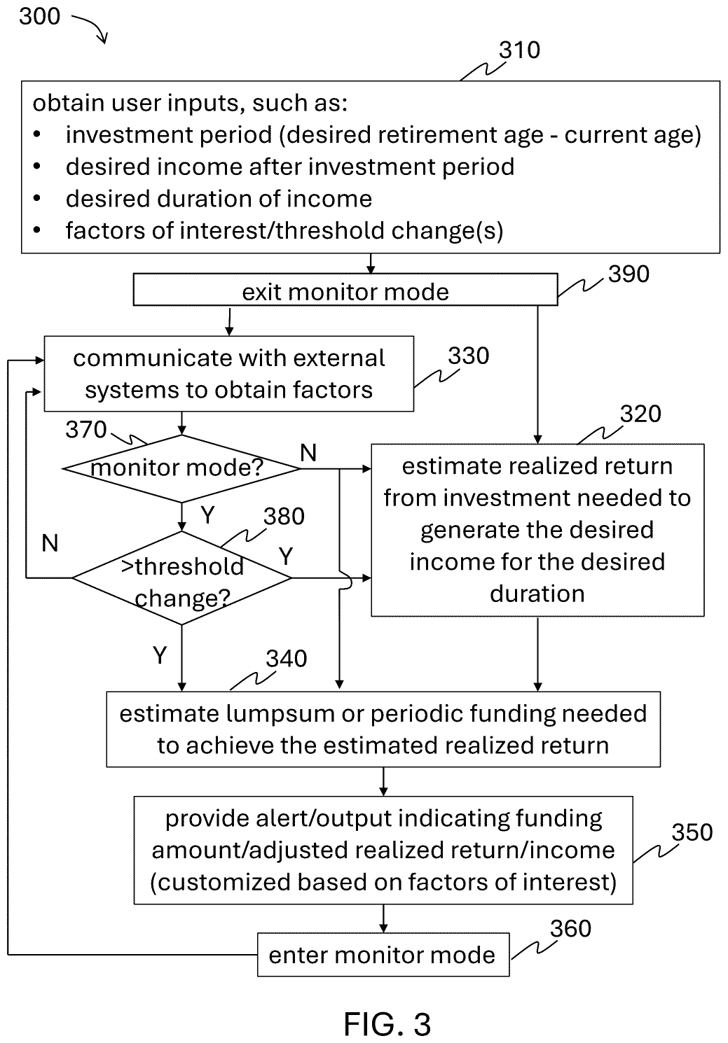

FIG. 3 is process flow of a financial management method 300 according to some embodiments. The method 300 includes additional aspects to those discussed with reference to FIGS. 1 and 2. The additional aspects are discussed but details of similarities with the methods 100 and 200 are omitted. The embodiments associated with FIG. 3 include a monitoring function of the financial management system 300. At 310, obtaining user inputs may include factors (additional to rate of return) that are of interest to the investor, similar to 210. In addition, threshold change may be selected individually for each factor of interest or generally (e.g., 5 percent change). The threshold change is discussed with reference to the processes at 380.

The user inputs may be stored and may be modified or augmented (e.g., additional factors of interest may be added) whenever the investor chooses to implement the method 300. Like the method 100, 200, method 300 may also be implemented periodically (e.g., each year for the anniversary of the establishment of the investment) to update values and provide a report to the investor suggesting any necessary adjustments to funding amounts. According to embodiments associated with FIG. 3, the method 300 may additionally be implemented partially or fully according to a monitoring operation.

After the investment is initially established and output is provided to the investor with an initial lumpsum or periodic funding amount, the processes may then include entering a monitoring mode at 360. This results in the processes at 330 being implemented to communicate with external systems 460 (FIG. 4) that provide rate of return and any user-selected factors of interest from 310. At 370, a check is done of whether the processes at 330 were performed in monitor mode. If not, the processes at 320, 340, and 350 are performed similarly to the processes at 220, 240, and 250, respectively. If the check at 370 indicates that the factors were obtained at 330 in monitor mode, then a check is performed, at 380, to determine if one or more of the factors changed by more than a threshold change amount.

As previously noted, the user inputs may include the threshold change generally or for each factor of interest. If a general threshold change (e.g., a percentage such as 3 percent) is indicated among the user inputs at 310, that threshold change may also be used for rate of return. In the absence of a specified threshold change for one or more factors, default threshold change values may be used for those one or more factors. The change refers a change from the previous value of the factor. For example, if inflation rate is indicated as a factor of interest and a threshold change of 2 percent is additionally indicated, the check at 380 would determine whether the inflation rate indicated by the external system 460 (at 330) changed by more than 2 percent from the previous indicated inflation rate.

If any one or more factors are determined to have changed by more than a threshold change amount at 380, the processes at 320, 340, and 350 are performed similarly to the processes at 220, 240, and 250, respectively. In this case, an alert may be issued to the investor (e.g., via an automatically generated email, text message to a cellular device) to inform the investor of the updated information. Following the processes at 350, 360 is reached again to implement another monitoring cycle. A delay may be associated with the processes at 360 (e.g., 24 hours, 168 hours) to make the monitoring periodic (e.g., daily, weekly) rather than continuous.

The monitoring cycle may be interrupted by the investor implementing the method 300. That is, when the method 300 is started by the investor using a user interface 410 so that user inputs are obtained at 310, exiting monitor mode is implemented at 390. Thus, the processes at 330 are followed by the processes at 320, 340, and 350 (followed by 360) according to the check at 370 indicating that monitor mode is not being implemented based on 390.

The monitoring cycle may also be interrupted by a periodic implementation of the method 300. This may automatically occur on the yearly anniversary of the establishment of the investment, for example. In this case, the processes would be initiated at 390 to implement the method 300 outside the monitor mode. Once output is obtained at 350 for the annual report, for example, the monitor mode is initiated again at 360.

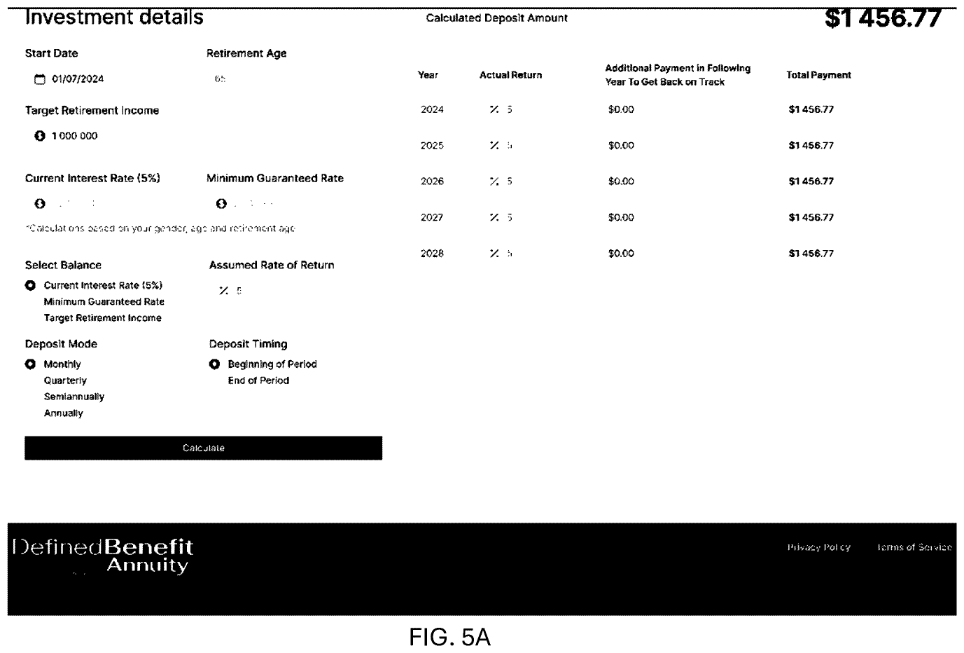

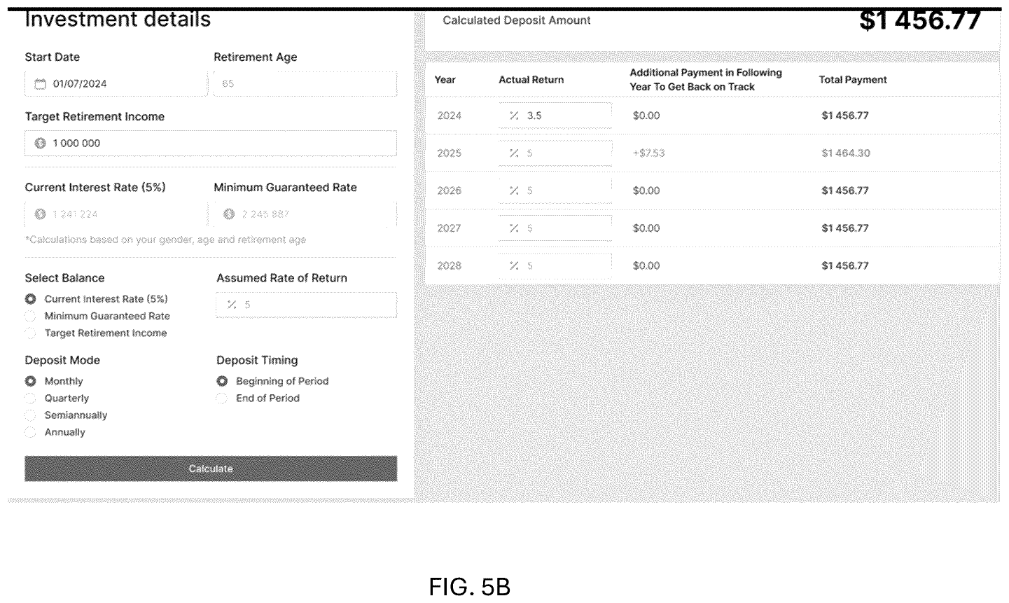

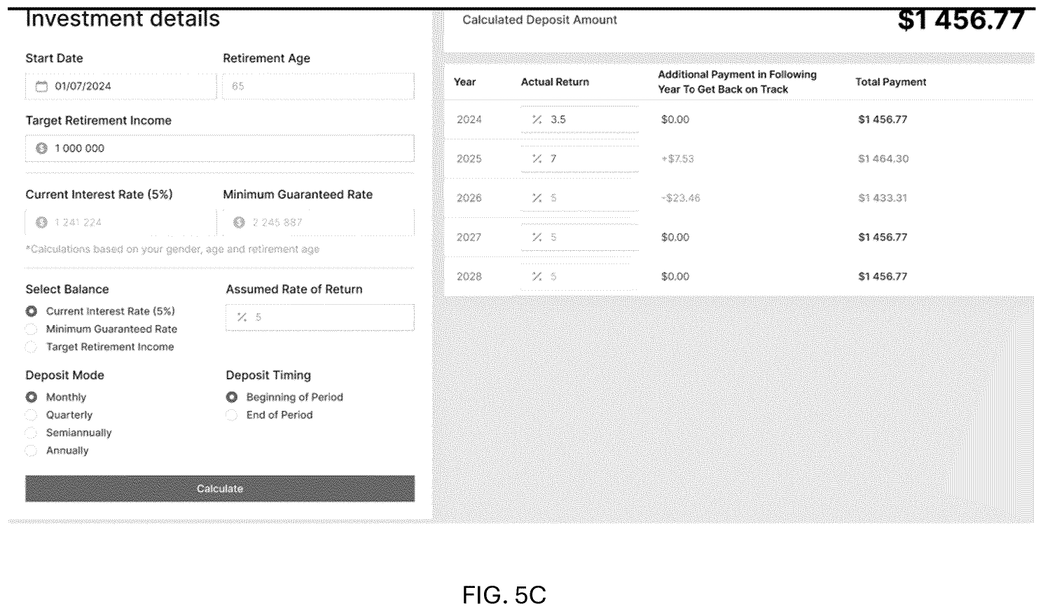

FIG. 4 is a block diagram of a financial management system 400 according to some embodiments. A user interface 410 may facilitate obtaining user input at 110, 210, 310. The user interface 410 may include a keyboard, mouse, monitor, or other known device that facilitates input being provided by the investor (at 110, 210, 310) and output being provided to the investor (at 150, 250, 350). The user interface 410, according to some embodiments, may be a graphical user interface provided as part of a financial management application. The application may provide selections in the form of selectable lists or pull-down menus, for example, for factors of interest, desired retirement age, withdrawal period, and the other user inputs discussed with reference to FIGS. 1, 2, and 3. Some user inputs such as desired income during the withdrawal period, for example, may be entered rather than selected. FIGS. 5A, 5B, and 5C show exemplary views of graphical user interface of an application that implements the financial management method, according to some embodiments, by indicating adjustments to funding resulting from a difference between assumed and actual rates of return.

Returning to the discussion of the discussion of the financial management system 400 shown in FIG. 4, one or more processors 420 may implement the methods 100, 200, 300 by processing instructions stored in a non-transitory computer-readable medium 440. Memory 430 may be used to store the user inputs, previously obtained values of factors, and the like. A communication interface 450 may facilitate wired or wireless communication with any number of external systems 460A through 460N (generally referred to as 460) directly or through a network 470 (e.g., cloud server). The aspects of the financial management system 400 that implement the methods 100, 200, 300 may be referred to collectively as processing circuitry.

Although explanatory embodiments have been described, other embodiments are possible. Therefore, the spirit and scope of the claims should not be limited to the description of the exemplary embodiments. Various modifications and variations can be made without departing from the scope and principle of the present disclosure.

1. A computer-implemented method comprising:
obtaining, using processing circuitry, for each of a plurality of users, user inputs associated with one or more user-associated investments, the user inputs indicating an investment period, which is a period after which distribution of a realized return of the one or more user-associated investments will begin, and a desired future income from a combination of the one or more user-associated investments at an end of the investment period;
obtaining, from one or more of the plurality of users, selection of one or more user-selected factors that affect the realized return of the one or more user-associated investments, the one or more user-selected factors including current inflation or projected inflation at an end of the investment period;
obtaining an associated threshold change associated with the one or more user-selected factors;
estimating and indicating, using the processing circuitry, for each of the plurality of users, a funding amount needed for the combination of the one or more user-associated investments to realize the desired future income at the end of the investment period, wherein, for each of the plurality of users,
estimating the funding amount includes estimating the funding amount at a first instance among a plurality of instances, the first instance being a start of the investment period for the user, and estimating the funding amount being estimating an amount to realize the desired future income based on estimated rate of return of the one or more user-associated investments at the start of the investment period for the user and the investment period for the user,
estimating the funding amount includes estimating a change in the funding amount at additional ones of the plurality of instances, and
estimating the change in the funding amount at each of the additional ones of the plurality of instances is based on changes in the estimated rate of return of the one or more user-associated investments at the instance as compared with the estimated rate of return of the one or more user-associated investments at a most recent previous instance among the plurality of instances and time remaining in the investment period;
obtaining, for each of the one or more of the plurality of users, from one or more other systems using the processing circuitry, values of the one or more user-selected factors that affect the realized return of the one or more user-associated investments;
determining, for the one or more of the plurality of users, at a different instance than one of the plurality of instances for the user, whether a change in any of the values of the one or more user-selected factors exceeds the associated threshold change associated with the one or more user-selected factors; and
proceeding with estimating the change in the funding amount at the different time than one of the plurality of instances for the user and providing an alert indicating the change in the funding amount to a corresponding one of the one or more of the plurality of users only when the change in any of the values of the one or more user-selected factors exceeds the associated threshold change associated with the one or more user-selected factors.

2. The method according to claim 1, wherein obtaining the associated threshold change associated with the one or more user-selected factors includes obtaining a different associated threshold change for each of the one or more user-selected factors.

3. The method according to claim 1, wherein, for at least one of the one or more of the plurality of users, obtaining the associated threshold change associated with the one or more user-selected factors includes obtaining at least one associated threshold change from the user.

4. The method according to claim 1, wherein, for at least one of the one or more of the plurality of users, obtaining the associated threshold change associated with the one or more user-selected factors includes obtaining a default threshold change value.

5. The method according to claim 1, wherein estimating the funding amount includes estimating an amount of a lump sum payment or periodic payment.

6. The method according to claim 1, wherein estimating the change in the funding amount includes estimating an additional lumpsum payment after a prior payment or a change in a current periodic payment.

7. The method according to claim 1, wherein the one or more user-selected factors includes a currency exchange rate.

8-10. (canceled)

11. A non-transitory computer-readable medium configured to store instructions which, when processed by one or more processors, cause the one or more processors to implement a method, the method comprising:
obtaining, for each of a plurality of users, user inputs associated with one or more user-associated investments, the user inputs indicating an investment period, which is a period after which distribution of a realized return of the one or more user-associated investments will begin, and a desired future income from a combination of the one or more user-associated investments at an end of the investment period;
obtaining, from one or more of the plurality of users, selection of one or more user-selected factors that affect the realized return of the one or more user-associated investments, the one or more user-selected factors including current inflation or projected inflation at an end of the investment period;
obtaining an associated threshold change associated with the one or more user-selected factors;
estimating and indicating, for each of the plurality of users, a funding amount needed for the combination of the one or more user-associated investments to realize the desired future income at the end of the investment period, wherein, for each of the plurality of users,
estimating the funding amount includes estimating the funding amount at a first instance among a plurality of instances, the first instance being a start of the investment period for the user, and estimating the funding amount being estimating an amount to realize the desired future income based on estimated rate of return of the one or more user-associated investments at the start of the investment period for the user and the investment period for the user,
estimating the funding amount includes estimating a change in the funding amount at additional ones of the plurality of instances, and
estimating the change in the funding amount at each of the additional ones of the plurality of instances is based on changes in the estimated rate of return of the one or more user-associated investments at the instance as compared with the estimated rate of return of the one or more user-associated investments at a most recent previous instance among the plurality of instances and time remaining in the investment period;
obtaining, for each of the one or more of the plurality of users, from one or more other systems, values of the one or more user-selected factors that affect the realized return of the one or more user-associated investments;
determining, for the one or more of the plurality of users, at a different instance than one of the plurality of instances for the user, whether a change in any of the values of the one or more user-selected factors exceeds the associated threshold change associated with the one or more user-selected factors; and
proceeding with estimating the change in the funding amount at the different time than one of the plurality of instances for the user and providing an alert indicating the change in the funding amount to a corresponding one of the one or more of the plurality of users only when the change in any of the values of the one or more user-selected factors exceeds the associated threshold change associated with the one or more user-selected factors.

12. The non-transitory computer-readable medium according to claim 11, wherein obtaining the associated threshold change associated with the one or more user-selected factors includes obtaining a different associated threshold change for each of the one or more user-selected factors.

13. The non-transitory computer-readable medium according to claim 11, wherein, for at least one of the one or more of the plurality of users, obtaining the associated threshold change associated with the one or more user-selected factors includes obtaining at least one associated threshold change from the user.

14. The non-transitory computer-readable medium according to claim 11, wherein, for at least one of the one or more of the plurality of users, obtaining the associated threshold change associated with the one or more user-selected factors includes obtaining a default threshold change value.

15. The non-transitory computer-readable medium according to claim 11, wherein estimating the funding amount includes estimating an amount of a lump sum payment or periodic payment.

16. The non-transitory computer-readable medium according to claim 11, wherein estimating the change in the funding amount includes estimating an additional lumpsum payment after a prior payment or a change in a current periodic payment.

17. The non-transitory computer-readable medium according to claim 11, wherein the one or more user-selected factors includes a currency exchange rate.

18-20. (canceled)
